(19) United States
(12) Patent Application Publication
(10) Pub. No.: US 2003/0007525 A1
(43) Pub. Date: Jan. 9, 2003

(54) Modulation current compensation of a laser for fixed extinction ratio using bias shifting

(76) Inventor: Chih-hao Chen, Huntington Beach, CA (US)

Correspondence Address: JONES VOLENTINE, P.L.L.C., SUITE 150, 12200 SUNRISE VALLEY DRIVE, RESTON, VA, 20191, US

(21) Appl. No.: 09/897,777

(22) Filed: Jun. 29, 2001

(51) Int. Cl. H01S 3/13

(52) U.S. Cl. 372/31

(57) ABSTRACT

A method and apparatus for controlling the extinction ratio and average output power of an optical device is disclosed. The method includes calculating a ratio of a first slope of a first characteristic curve to a second slope of a second characteristic curve. A modulation current is calculated based on the ratio.

### FIELD OF THE INVENTION

The invention relates generally to optical communications, and specifically to a method and apparatus for maintaining the extinction ratio and average optical output power of a laser device over time and temperature variations.

### BACKGROUND OF THE INVENTION

Digital fiber-optic communications have gained widespread acceptance for both telecommunications and data communication applications. Telecommunication systems typically operate over single mode fiber at distances from 10 kilometers to over 100 kilometers and employ lasers emitting at wavelengths of 1310 nm or 1500 nm. Data communication systems typically cover shorter distances of up to a few kilometers, often over multi-mode fiber. Data communication systems can employ laser devices as well, typically having emission wavelengths of 650 nm to 850 nm. As the data rates of the transmission in the telecommunications and data communications industries continue to increase, there are ever increasing demands placed on the various components of the optical communication system.

In modern optical communications, an optical carrier signal is often digitally modulated. As can be appreciated, this digital modulation results in a series of “high” (digital “one” bit) and “low” (digital “zero” bit) power outputs by the laser device. As can be appreciated, it is important to maintain respective optical output the power levels of the digital “high” and digital “low”. To this end, at the receiver end, the received optical signal is converted to an electrical signal. The digital “high” corresponds to a particular voltage level, while the digital “low” corresponds to another voltage level. If, for some reason, the optical power is not maintained at a suitable level such that the converted electrical signal is not above a particular threshold for a digital “high”, or the optical output power of a digital “low” is not sufficiently low that the electrical signal is below a particular threshold, errors in the signal transmission may result. These errors are ultimately manifest in unacceptable bit error ratios (BER).

As can be appreciated, it is useful to constantly monitor the output of an optical transmitter, such as an optical laser to ensure that the optical signal transmitted has output power levels for digital “highs” and “lows” that are at certain power levels. One measure of the output of a laser is known as the extinction ratio. The extinction ratio is a measure of the amplitude of the digital modulation on the optical carrier. The extinction ratio is defined as the average optical power of a digital logic one bit (high) divided by the average optical energy in a digital logic zero bit (low):

$$E = \frac{{P}_{1}}{{P}_{0}} \qquad ( 1 )$$

where E is the extinction ratio; P₁ is the average optical power in a logic one bit; and P₀ is the average optical power in a logic zero bit. Standards for communication systems such as the synchronous optical network (SONET) or SDH specify minimum extinction ratio requirements for laser transmitters. Specifically, when a laser is digitally modulated for signal transmission, the extinction ratio of the modulated laser should be kept nearly constant for better transmission of the signal. Normally, there is a minimum extinction ratio requirement set by the standard, and it is important to maintain the extinction ratio of the digitally modulated laser in an optical transmission system at or above this minimum requirement. This ensures that the BER is maintained to the standard of the particular optical communication system in which the laser is deployed.

As is known, the extinction ratio may be impacted by a variety of influences in an optical communication system. Two influences are the affects of temperature and aging on a laser or other active device used for the optical signal transmission. The influences of temperature and aging on the output of the laser may be readily understood from the characteristic curves of a laser such as that shown in FIG. 1, which is a graph of the optical power versus laser current for a laser. Characteristic curve 101 is the optical output power versus laser current for a laser at a first temperature, prior to the impact of aging. Contrastingly, characteristic curve 102 is the optical power versus laser current of a laser device impacted by elevated temperature and/or aging.

Illustratively, a chosen extinction ratio (P₁/P₀) may be defined as shown in FIG. 1. As can be appreciated, for the laser operating along curve 101, output P₁ corresponds to a particular laser current 103; and optical output power P₀ corresponds to a particular laser current 104. However, as the laser ages and/or is subject to an increased temperature, it illustratively operates along characteristic curve 102. If the laser current levels are maintained at 103 for the optical power of a logic one bit, and at laser current level 104 for a logic zero bit, the output of the laser operating along characteristic curve 102 will be significantly reduced. Specifically, the output power for a logic one bit will be P₁′, and the output power for a logic zero bit will be P₀′, as is shown in FIG. 1. As can be readily appreciated, the extinction ratio

$$( \frac{{P}_{1}^{′}}{{P}_{0}^{′}} )$$

will be reduced to unacceptable levels. Accordingly, the bit error ratio will be unacceptably low, and transmission of voice and data may be severely impacted.

Moreover, it is often useful to maintain the average power of the optical signal at a predetermined level. Illustratively, this average power is the average of the optical power of a logic one bit and the optical power of a logic zero bit. For example, the average optical power for a device operating along characteristic curve 101 is at a predetermined value, Pₐᵥ. This illustrative predetermined value may be one set by a particular standard. As the effects of time and aging impact a device, the average power may also be significantly impacted. For example, the average of P₁′ and P₀′ is Pₐᵥ′ which may be unacceptably low.

One conventional method of controlling an output of a laser is to incorporate a thermoelectric cooler into a laser package so as to keep the laser at a constant temperature. As such, the laser will operate along a particular characteristic curve. Accordingly, the extinction ratio can be maintained at a constant level. However, there are certain disadvantages to this approach. For example, thermoelectric coolers tend to increase the cost of the device; increase the size of laser package; and decrease the reliability of the laser, since any failure of the thermoelectric cooler or its circuitry may result in the application of an inappropriate bias current as the temperature of the laser varies. Moreover, thermoelectric coolers may be difficult to implement in a variety of environments. Finally, the thermoelectric cooler does not mitigate the effects of aging on the device, which can equally impact the extinction ratio and average output power of the device over time.

Another conventional approach to maintaining the extinction ratio of a laser is through the use of a controller which makes suitable adjustments in the bias and/or modulation current to account for the effects of time and/or temperature based on historical statistical data of the laser. These controllers may incorporate a look-up table which includes the historical statistical time and temperature data for each individual laser. While this approach has shown promise in the past, it is, nonetheless, solely dependent upon historical statistical data. Therefore, devices which have not been subjected to age and/or temperature testing, for example, cannot be compensated using this convention scheme. This is particularly problematic, since many of the devices implemented in current and next-generation high-speed applications do not have such data.

Accordingly, while conventional techniques to maintain the extinction ratio have had some success, they clearly have their shortcomings some of which are described above.

What is needed, therefore, is a technique which substantially maintains the extinction ratio of a laser by correcting for both temperature induced changes as well as age induced changes in the slope of a laser device that overcomes the shortcomings of the conventional techniques described above.

### SUMMARY OF THE INVENTION

According to an illustrative embodiment of the present invention, a method of controlling an optical device includes calculating a ratio of a first slope of a first characteristic curve to a second slope of a second characteristic curve; and calculating a modulation current based on the ratio.

According to another illustrative embodiment of the present invention, an apparatus for controlling an optical device includes a controller which calculates a ratio of a first slope of a first characteristic curve. The controller calculates a modulation current based on the ratio, and a driver which introduces the modulation current to the optical device.

### BRIEF DESCRIPTION OF THE DRAWINGS

The invention is best understood from the following detailed description when read with the accompanying drawing figures. It is emphasized that the various features are not necessarily drawn to scale. In fact, the dimensions may be arbitrarily increased or decreased for clarity of discussion.

FIG. 1 is a graphical representation of optical power versus laser current showing the effects of temperature and/or aging on a laser.

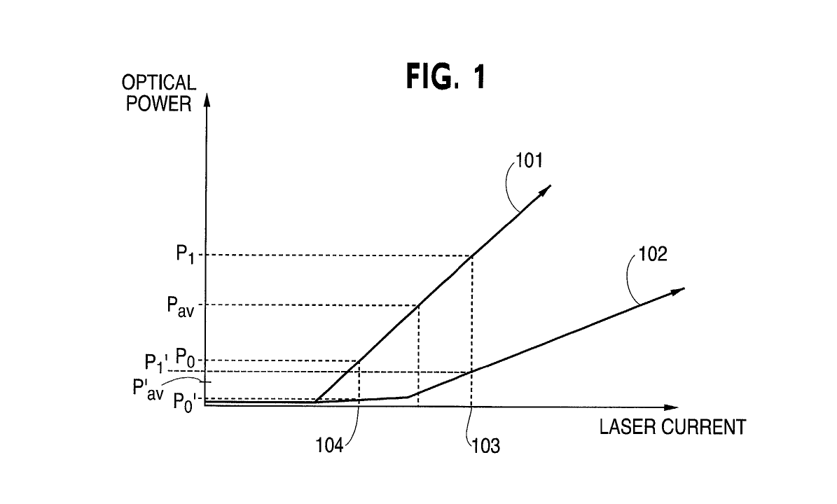

FIG. 2 is a graphical representation of optical power versus laser current showing the change in slope of a characteristic curve of a laser due to temperature and aging effects, as well as the extinction ratio, (E), initial modulation current (I_{mod}_{_{—}}ᵢₙₜ), and required modulation current (I_{mod}_{_{—}}_{req}), in accordance with an illustrative embodiment of the present invention.

FIG. 3 is a functional block diagram of a monitor laser driver feedback loop in accordance with an illustrative embodiment of the present invention.

FIG. 4 is a flow chart of an illustrative method for calculating the slope of an initial characteristic curve in accordance with an illustrative embodiment of the present invention.

FIG. 5 is a flow chart of an illustrative method for modulation current compensation in accordance with an illustrative embodiment of the present invention.

FIG. 6 is a graphical representation of optical power versus laser current showing the change in slope of a characteristic curve of a laser due to temperature and aging effects, as well as the extinction ratio, (E), initial modulation current (I_{mod}_{_{—}}ᵢₙₜ), and required modulation current (I_{mod}_{_{—}}_{req}), in accordance with an illustrative embodiment of the present invention.

FIG. 7 is a flow chart of an illustrative method for calculating the slope of an initial characteristic curve in accordance with an illustrative embodiment of the present invention.

FIG. 8 is yet another flow chart of an illustrative method for modulation compensation according to another illustrative embodiment of the present invention.

### DETAILED DESCRIPTION

In the following detailed description, for purposes of explanation and not limitation, exemplary embodiments disclosing specific details are set forth in order to provide a thorough understanding of the present invention. However, it will be apparent to one having ordinary skill in the art having had the benefit of the present disclosure, that the present invention may be practiced in other embodiments that depart from the specific details disclosed herein. Moreover, descriptions of well-known devices, methods and materials may be omitted so as to not obscure the description of the present invention.

Briefly, the present invention relates to a method and apparatus for maintaining the extinction ratio and average output optical power of a digital optical signal from an optical transmitter over temperature and time. According to an illustrative embodiment of the present invention, small changes may be made to the laser D.C. bias current (I_{DC}) for a fixed change in output power. These variations are then used to calculate the slope of the initial characteristic curve, and the slope of characteristic curve of the laser after the affects of temperature and/or aging have impacted device performance. From these slopes, the required modulation current is calculated. Independently, any required change in the D.C. bias (ΔI_{DC}) current may be determined, and the average output optical power may be maintained. According to the above illustrative embodiment of the present invention, the extinction ratio and average output optical power may be maintained substantially constant over temperature and/or time.

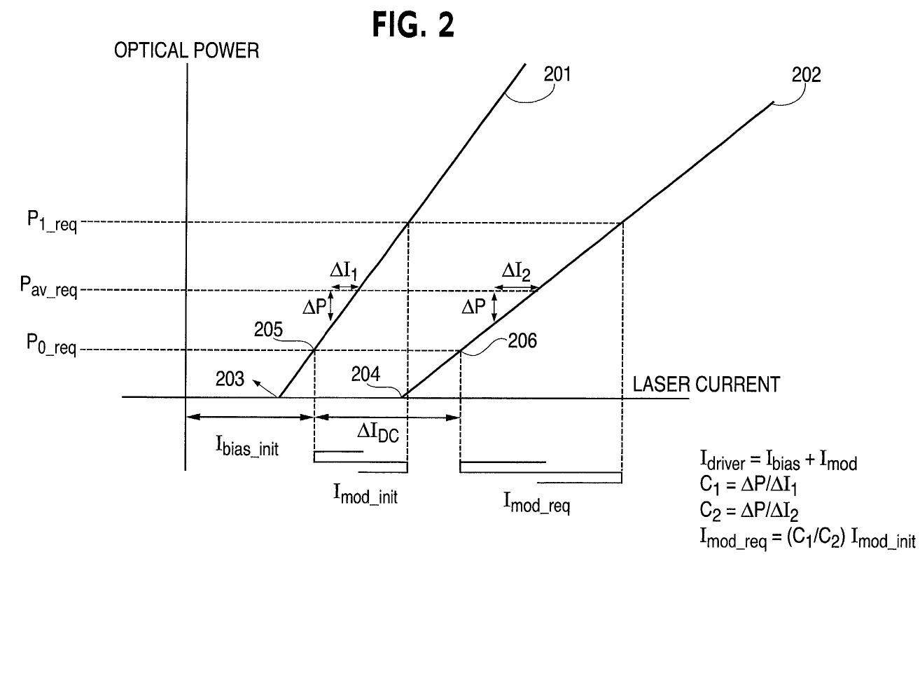

Turning to FIG. 2, the output optical power versus laser current for a laser is shown. Characteristic curve 201 represents the optical power of a laser at an initial temperature and before the affects of aging are manifest. As can be appreciated, the laser is operating in the linear region of characteristic curve 201. A threshold current 203 is the minimum current at which the laser turns on. The laser operates substantially linearly in the operational range shown. The initial modulation current (I_{mod}_{_{—}}ᵢₙᵢₜ) modulates the laser, resulting in its operation between a required output power for a digital one bit (P₁_{_{—}}_{req}) and output power for a digital zero bit (P₀_{_{—}}_{req}). The ratio of these two powers (P₁_{_{—}}_{req}/P₀_{_{—}}_{req}) is the required extinction ratio (E) of the device. This required extinction ratio may be one set by a particular standard such as those mentioned above.

The characteristic curve 202 is the operational characteristic of the same laser device after the effects of temperature and/or aging. Again, as can be appreciated the laser is operating in the linear region of characteristic curve 202. In order to maintain the required extinction ratio, the modulation current must be changed to a required modulation current (I_{mod}_{_{—}}_{req}) as shown. Moreover, and independently, the D.C. bias (I_{DC}) current must also be changed to account for the shift in the D.C. bias due to temperature and/or aging. This change in I_{DC} (shown as ΔI_{DC}) assures the average output optical power is maintained at its desired level. To wit, as shown at 204 on characteristic curve 202 the threshold current required to turn the laser on is increased due to the affects of aging and/or temperature. Thereafter, the laser operates in a substantially linear region of characteristic curve 202. The laser is biased above this threshold level (e.g. at 205 of curve 201 and at 206 of curve 202), to reduce relaxation oscillation. As such, it is necessary to increase to D.C. bias by ΔI_{DC}, to maintain the extinction ratio and power at desired levels after I_{mod}_{_{—}}_{req} is derived and applied.

According to an illustrative embodiment of the present invention, the slope of characteristic curve 201 and the slope of characteristic curve 202 may be used in combination with the initial modulation current (I_{mod}_{_{—}}ᵢₙᵢₜ) to calculate the required modulation current (I_{mod}_{_{—}}_{req}). Moreover, the method according to the illustrative embodiment is also designed to ensure that the required average power (Pₐᵥ_{_{—}}_{req}) is maintained. To this end, according to the illustrative embodiment of the present invention, not only is the extinction ratio maintained, but also the average output power.

As shown in FIG. 2, a relatively small change in the D.C. bias input (ΔI₁) is made to effect a small decrease in the output power (ΔP). From this change, the slope of characteristic curve is:

$${C}_{1} = \frac{Δ P}{Δ {I}_{1}} \qquad ( 2 )$$

where C₁ is the slope of characteristic curve 201.

Similarly, a change in the D.C. bias current, ΔI₂, may be made to effect an identical decrease in the optical power, ΔP. From this, the slope of the characteristic curve 202 may be determined. Specifically,

$${C}_{2} = \frac{Δ P}{Δ {I}_{2}} \qquad ( 3 )$$

where C₂ is the slope of characteristic curve 202.

Taking the ratio of C₁ to C₂ yields,

$$\frac{{C}_{1}}{{C}_{2}} = \frac{Δ {I}_{2}}{Δ {I}_{1}} = S \qquad ( 4 )$$

which may be referred to as the slope coefficient, S.

The ratio of the slopes of characteristic curves 201 and 202 may be used to scale the initial modulation current (I_{mod}_{_{—}}ᵢₙᵢₜ) to its required level (I_{mod}_{_{—}}_{req}) to maintain the required extinction ratio ER.

To this end, from straight-forward analysis it can be shown that

(S)(I_{mod}_{_{—}}ᵢₙᵢₜ)=I_{mod}_{_{—}}_{req}. (5)

The calculated required modulation current (I_{mod}_{_{—}}_{req}) and the appropriate change in the bias current (ΔI_{DC}) may be used to substantially maintain the extinction ratio and average output power of the device over time and/or temperature. Accordingly, once the required change in the D.C. bias current, ΔI_{DC}, and required modulation current, I_{mod}_{_{—}}_{req}, are determined, the required laser current, I_{req}, is given by:

I_{req}=I_{bias}_{_{—}}ᵢₙᵢₜ+ΔI_{DC}+I_{mod}_{_{—}}_{req} (6)

Certain observations are particular noteworthy. First, because the change in the modulation current (ΔI₁, ΔI₂) is relatively small, the decrease in the optical power which may be detected at a laser monitor is merely a small perturbation that does not interfere significantly with the performance of the transmission of the main data. As such, the present invention may be incorporated into a deployed device. Moreover, the present invention functions without the need for historical statistical data. To this end, the present invention iteratively performs the above described method, without any a priori information of the effects of aging and/or temperature on a particular laser device. As can be readily appreciated, this results in a substantial degree of versatility and ready deployment in operational optical communication systems.

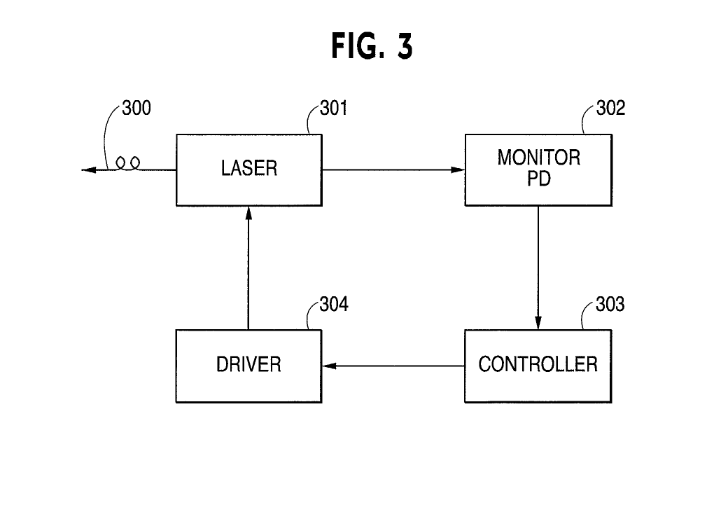

FIG. 3 shows a functional block diagram of a feedback control circuit according to an illustrative embodiment of the present invention. This feedback control circuit may implement modulation current and D.C. bias current modulation schemes in accordance with illustrative embodiments of the present invention to maintain the extinction ratio and average output power at substantially constant levels. To this end, a laser 301 emits a signal to an optical fiber 300 which is connected to an optical communication system (not shown). A portion of the light from the laser 301 is impingent a monitor photodetector 302. Illustratively, if the laser is a semiconductor laser such as a laser diode, the rear facet of the laser emits a portion of the light that is received by monitor photodetector 302. Alternatively, an optical tap may be used to divert a small portion of the laser output to the monitor photodetector.

The monitor photodetector 302 transforms the optical signal received into an electrical signal. This electrical signal is input to a controller 303, which performs the requisite calculations in accordance with illustrative embodiments of the present invention to substantially maintain ER and Pₐᵥ_{_{—}}_{req} at constant levels. The controller 303 then issues controller command to the driver 304. The controller commands include a modulation current control and a bias current control signal. The driver 304 includes an automatic power controller (APC), which controls the D.C. bias of the laser. The driver 304 also includes a modulation current controller that controls the modulation current to the laser. Based on the controller commands from the controller 303, the driver 304 changes the D.C. bias current and modulation current, as needed, to maintain the extinction ratio of the laser 301 and the average power of the laser, each at prescribed levels of operation.

It is noted that the control apparatus and method is illustratively applied to a laser, such as a semiconductor laser. Of course, this is not intended to be limiting, but rather illustrative of the invention. Namely, the control apparatus and method of the present invention may be applied to other devices which are impacted by temperature and/or aging affects. Such devices will be within the purview of one having ordinary skill in the art.

As can be appreciated from the above discussion, an extinction ratio and average power level are predetermined for a particular application. To this end, the initial characteristic curve of a particular laser (e.g. laser 301 of the illustrative embodiment of FIG. 3) in a deployed system is used to set the D.C. bias and modulation currents for the desired extinction ratio and average power output of the laser. For example, in the illustrative embodiment shown in FIG. 2, characteristic curve 201 may be the initial curve for a particular laser in a deployed system. The laser will have a slope, C₁, and threshold current 203 as shown in FIG. 2. Of course, it is necessary to calculate the slope, C₁ of the initial characteristic curve of the deployed laser after the output power monitor 302 has been calibrated. As is required by most of fiber communication standards, the output voltage of the monitor PD 302 should be first calibrated at the ratio of 500 mV per 1 mW of optical output laser output power. Hence, the controller 303 can read the monitor PD 302 output to derive the respective optical power and perform the required calculation as described above. An illustrative method of calculating the slope of the initial characteristic curve of the laser is described presently.

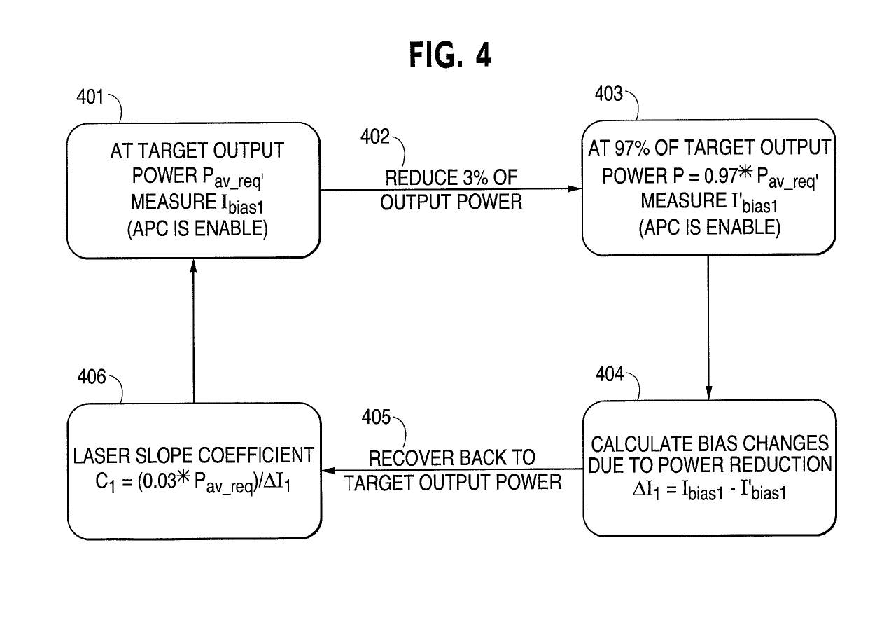

Turning to FIG. 4, a flow chart of a method for calculating the slope of an initial characteristic curve, C₁, of a deployed laser, according to an illustrative embodiment of the present invention is shown. At 401, the initial bias current, I_{bias1}, is determined for a particular target output power (Pₐᵥ_{_{—}}_{req}). In this initial sequence, the APC is enabled, and as such the D.C. bias is maintained. Next, the D.C. bias current is reduced by a relatively small amount to reduce the output power. Illustratively, the D.C. bias current is reduced so that the output power, Pₐᵥ_{_{—}}_{req}, is reduced by approximately 3%. The illustrative 3% power reduction is chosen because the reduction amount is small enough to not disturb the signal transmission performance (e.g., BER) but also large enough to yield a relative good signal-to-noise ratio over the Analog-to-Digital Conversion (ADC) sampling noise incurred at controller 303. Illustratively, a power reduction in the range of approximately 2% to approximately 5% is acceptable in accordance with the present exemplary embodiment

Next, as shown at 403, with the APC enabled and the target output power P set to 0.97 Pₐᵥ_{_{—}}_{req}, the bias current is measured. It is noted that the APC is enabled during this measurement because this power control loop will automatically adjust the bias current to maintain the output power at target 0.97 Pₐᵥ_{_{—}}_{req} level. With the measured bias current I_{bias1}, the change in the bias current due to the power reduction is calculated as shown at 404. To this end, the change in the bias current ΔI₁ (see FIG. 2) may be determined by subtracting I′_{bias1} from the initial bias current, I_{bias1}, required for the target output power Pₐᵥ_{_{—}}_{req}. Next, as shown at 405, the bias current is returned to a level necessary to maintain the target output power, Pₐᵥ_{_{—}}_{req}, at its desired output level. As shown at 406, the slope (C₁) of the initial characteristic curve may readily calculated.

Once the slope of the initial characteristic curve, C₁, is calculated, and the initial bias and modulation current values for a particular extinction ratio and average output power are known, these data may be used in subsequent calculations to make the requisite adjustments in both bias current and modulation current at any temperature and at any age of a particular laser. As mentioned before, the bias and modulation current calculations and adjustments are made independently of one another. Advantageously, the iterative technique described herein enables the continuous compensation of the extinction ratio and average output power.

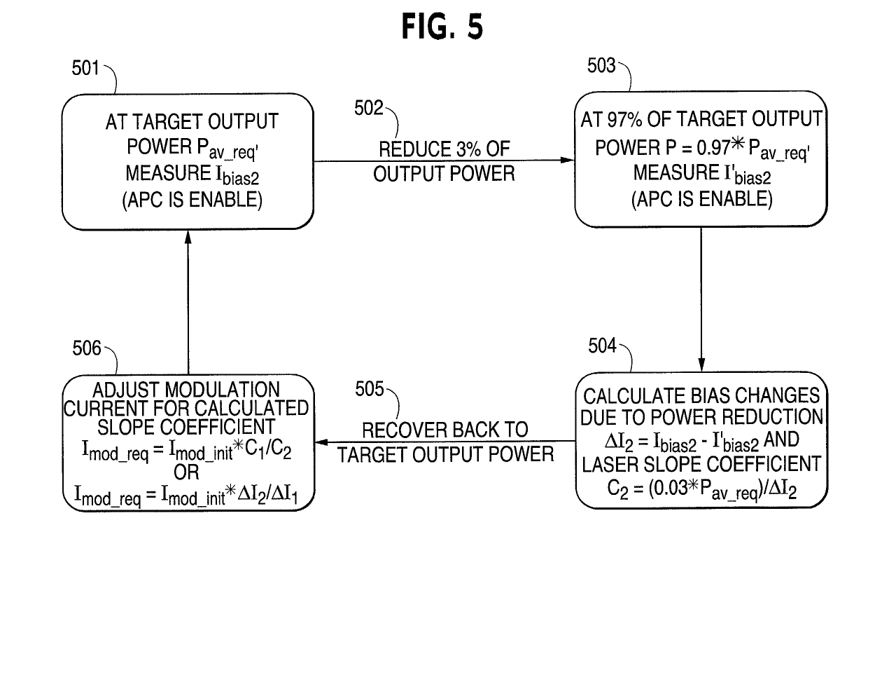

Turning to FIG. 5, an illustrative method is shown for calculating the required modulation current and adjusting the modulation current to maintain the extinction ratio of a laser at prescribe levels. The illustrative method shown in FIG. 5 is effected in a continual manner to account for changes in the characteristic curve of the laser due to temperature and aging effects. As shown at 501, at the particular target output power, Pₐᵥ_{_{—}}_{req}, the bias current is measured. Again, the APC is enabled. Illustratively, the characteristic curve due to temperature and/or aging would be one such as curve 202 in FIG. 2. Next, as shown at 502, the output power is reduced at a constant amount of approximately 3%. As shown at 503, at the reduced output power, the new bias current I′_{bias2} is measured with the APC enabled. Next, as shown at 504, the change in the bias current due to the power reduction is calculated. This calculation is the calculation of 12 (see FIG. 2). With these values, the slope of the characteristic curve of a laser impacted by temperature and/or time (such as slope C₂ of characteristic curve 202 of FIG. 2) may be calculated. Next, the bias current is changed to return to the target output power as shown at 505. Having determined the slope of the characteristic curve of the laser that has been effected by aging and/or temperature, the modulation current is adjusted. As shown at 505, the modulation current is calculated by the equations shown in 506 (which correspond to equation (5) above).

It is of interest to note that any change in the D.C. bias current to compensate for the effects of temperature and/or aging could be implemented in parallel to the above method for adjusting the modulation current. To this end, the change in the D.C. bias, ΔI_{DC}, can be readily changed by having the controller 303 of FIG. 3 adjust the APC of the driver 304 by a particular finite amount to account for the shift in the bias current due to the effects of temperature and/or aging.

After making the necessary adjustments in the modulation current for the calculated slope at 506, the process is repeated. As such, any change in the output characteristics of a laser due to temperature and/or age may be quickly compensated by the iterative method of the illustrative embodiment in order to maintain the average output power and extinction ratio of the laser at a substantially constant level. The required iteration period of the exemplary modulation current compensation method of the present invention depends on the environmental thermal time constant, which is the temperature changing rate on the laser chip. Under normal operating conditions, an iteration rate from approximately a few hundred milli-seconds to approximately several seconds should be adequate. It is noted that some extinction ratio variation may be caused by the Analog-to-Digital conversion (ADC) noise contributed to the modulation current compensation ratio calculation described. Illustratively, this fluctuation in the extinction ratio is less than approximately 1 dB and may be as little as approximately 0.5 dB. The output power level is kept at a target level (i.e., Pₐᵥ_{_{—}}_{req}) with negligible power variation. However, because of the nature of the illustrative method, the optical output power will have an approximately 3% reduction and will also kept at this level during the slope calculation process as described above. It will recover back to original target power level after the modulation current compensation process is completed.

One major advantage of this invention is that the laser modulation control can be fully implemented in the firmware level with conventional bias, modulation and modulation ADC monitor ports; and conventional bias, modulation, and Digital-to-Analog conversion (DAC) ports of the controller 303. No additional hardware circuitry is required to implement the illustrative method of the present invention.

According to the illustrative embodiment described above, a small change in the D.C. bias current may be introduced to effect a constant change in the output power from the required average output power to calculate the slope of the initial characteristic curve as well as the slope of the characteristic curve of the device after the affects of temperature and/or aging. Of course, this is merely illustrative, and there are other ways in which to calculate the slopes of the two (or more) characteristic curves using a bias current in order to change the required modulation current as the effects of temperature and/or aging impact the performance of the laser. Another illustrative technique includes adding a relatively small constant current ΔI to the D.C. bias current of the laser. The increased output of the optical power ΔP relative to the required average output power, Pₐᵥ_{_{—}}_{req}, may be detected at the monitor photodetector without disturbing the performance of the transmission of data during the operation of the deployed device. These values of ΔI and ΔP may be used to calculate the respective slopes of the characteristic curves of a laser over time and/or temperature.

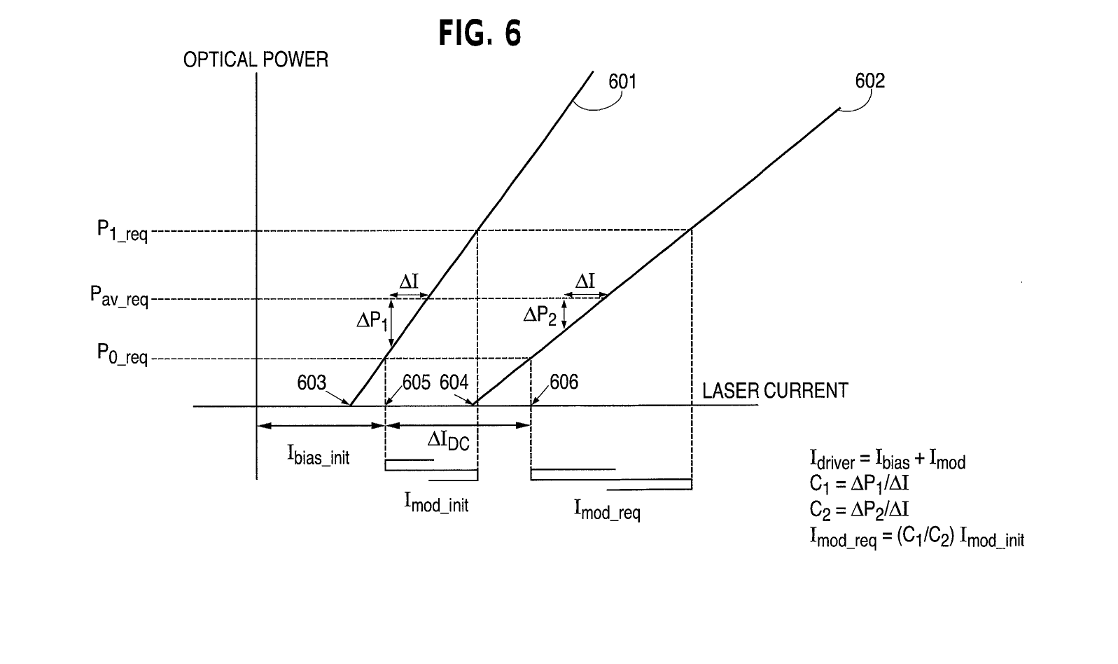

FIG. 6 is a graphical representation showing the implementation of the present exemplary method of calculating the slopes required to determine the required modulation current to maintain the extinction ratio at a predetermined level. Again, the average output power may be maintained independently by changing the D.C. bias using an APC. Characteristic curve 601 is the initial characteristic curve of a device, operating illustratively at 25° C. As can be appreciated, the laser is operating in the linear region of characteristic curve 201. As such, this becomes the calibration standard for compensating the modulation current to maintain the predetermined extinction ratio and average output power. To determine the slope of the characteristic curve 601, a small change in the D.C. bias current, ΔI is implemented. This results in a change, ΔP₁, of the average output power, as shown. The slope C₁ of the initial characteristic curve 601 may be calculated:

$${C}_{1} = \frac{Δ {P}_{1}}{Δ I} \qquad ( 7 )$$

Next, the slope of the characteristic curve 602 of the device resulting from the effects of aging and/or temperature is calculated. Again, as can be appreciated the laser is operating in the linear region of characteristic curve 202. Again, a change in the D.C. bias current, ΔI, is effected, and results in a change in the output power ΔP₂, of the device. The change in the D.C. bias current, ΔI, is identical to the change in the D.C. bias current of the device operating on characteristic curve 601. As before, the slope, C₂, of characteristic curve 602 may be readily determined:

$${C}_{2} = \frac{Δ {P}_{2}}{Δ I} \qquad ( 8 )$$

Next, the ratio of the slope of the initial characteristic curve 601 to the characteristic curve 602 after the effects of aging and/or temperature may be calculated:

$$\frac{{C}_{1}}{{C}_{2}} = \frac{Δ {P}_{1}}{Δ {P}_{2}} = S \qquad ( 9 )$$

where S is the slope coefficient of characteristic curves 601 and 602.

From straightforward analysis, therefore, it can be shown:

I_{mod}_{_{—}}_{req}=(S)(I_{mod}_{_{—}}ᵢₙᵢₜ) (10)

Next, it is necessary to compensate for any change in the D.C. bias current due to aging and/or temperature effects on the laser. To this end, the laser output power becomes positive at point 603 of curve 601. This is referred to as the threshold current. Thereafter, the laser operates in a substantially linear region as shown. However, as the effects of temperature and aging impact the laser, this threshold current tends to increase. As shown at 604 on characteristic curve 602, the threshold current required to turn the laser on is increased. Thereafter, the laser operates in a substantially linear region along curve 602. The laser is biased above the threshold level, (e.g., at 605 of curve 601 and 606 of curve 602), to reduce the relaxation oscillation. It is necessary to increase the D.C. bias current by ΔI, which is the difference between point 605 and point 606, to maintain the extinction ratio and power at desired levels after I_{mod}_{_{—}}_{req} is derived and applied. This is carried out illustratively by changing the output of the APC. This may be effected in parallel to any change in the modulation current required to maintain the extinction ratio.

Once the required change in the D.C. bias current ΔI_{DC}, and required modulation current, I_{mod}_{_{—}}_{req}, are determined, the required laser current, I_{req}, is given by:

I_{req}=I_{bias}_{_{—}}ᵢₙᵢₜ+ΔI_{DC}+I_{mod}_{_{—}}_{req} (11)

A structure such as shown in the illustrative embodiment of FIG. 3 may again be implemented to effect the iterative calculations and changes in the laser currents necessary to maintain the extinction ratio and average output power of the laser. To this end, the controller 303 may effect the above captioned calculations in an iterative manner, and instruct the driver 304 to make any requisite changes in the modulation current and D.C. bias current. The driver 304 would then implement these changes in the currents to the laser 301. Again, the D.C. bias value can be implemented using APC which operated independently of the modulation current driver.

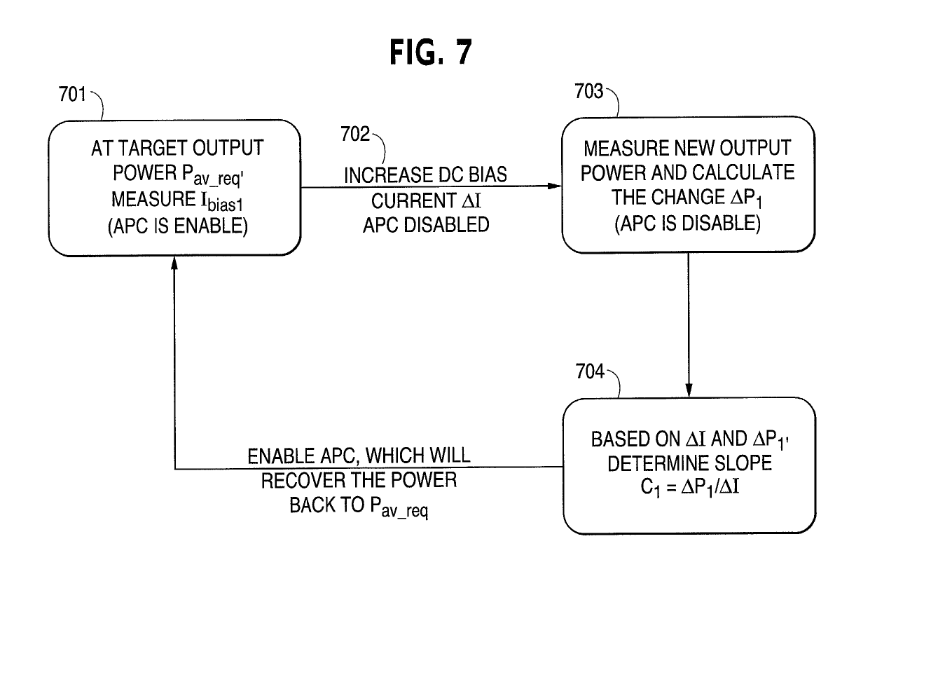

An illustrative method of calculating the slope of the initial characteristic curve 601 is shown in the flow chart FIG. 7. As shown at 701, the target output power Pₐᵥ_{_{—}}_{req} is shown at 701 and maintained by APC. A small change in the D.C. bias is implemented as shown at 702 and the APC should be disabled in the same time in order to calculate the changes in the power level. If APC is not disabled, the APC will re-adjust the bias current and still maintain the Pₐᵥ_{_{—}}_{req}, which violates the concept of the illustrative method. This change in the D.C. bias current, ΔI, results in an increase in the output power. At 703, the new output power is measured, and the change in the output power, ΔP₁, between the new output power and the target output power is calculated. Next, as shown in 704, based on the change in the D.C. bias current, ΔI, and the change in the output power ΔP₁, the slope C₁ of the initial characteristic curve 601 is determined. As described above, the slope C₁ of the initial characteristic curve is used as the calibration baseline for subsequent calculations of the required modulation current after the effects of temperature and/or aging impact the operational characteristics of the laser. After calculation of the slope, the APC is enabled to maintain the original power level Pₐᵥ_{_{—}}_{req}.

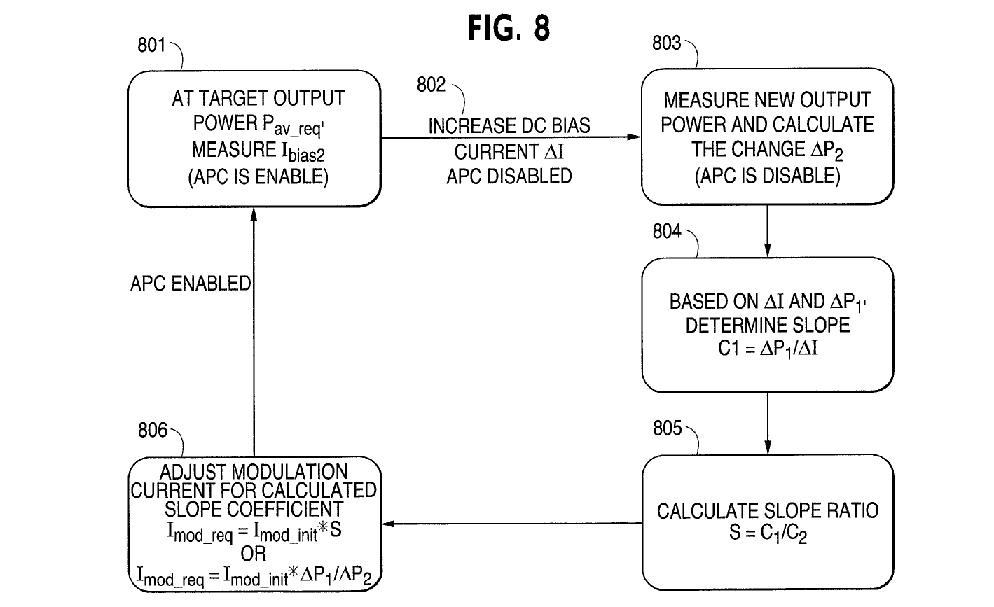

FIG. 8 shows a flow chart of an illustrative method for calculating the required modulation current according to an exemplary embodiment of the present invention. At step 801, the target output power, Pₐᵥ_{_{—}}_{req} is measured when APC is enabled. To calculate the new slope C₂, the APC is disabled and the D.C. bias current is increased by a constant amount, ΔI, which is identical to the increase in the D.C. bias current implemented at 702 in the illustrative embodiment of FIG. 7. Next, at 803, the new output power is measured, and the difference, ΔP₂, between the target output power and the new output power is calculated. At 804, the slope is calculated based on the increase in the D.C. bias current and the corresponding change in the output power ΔP₂. Once the slope C₂ is determined, the ratio of the slopes, S, is calculated at 805. Finally, at 806, the required modulation current is calculated. The iterative process then continues at 801 with the measure of the target output power.

The calculation of the slope of the initial characteristic curve 601 according to the illustrative method of FIG. 7, as well as the iterative method for calculating the required modulation current of the illustrative method of FIG. 8 may be implemented in an architecture such as shown in the illustrative embodiment of FIG. 3. To this end, the monitor photodetector would effect all measurements of output power and inputs the converted electrical signals therefrom to a controller 303. The controller 303 would effect the calculations such as those of the illustrative methods of FIGS. 7 and 8, and send requisite commands to the driver 304 to make any necessary changes in the modulation current as well as the required D.C. bias current to achieve the predetermined target output power, Pₐᵥ_{_{—}}_{req}, and extinction ratio, ER. As with the previous described method, the implementation of the illustrative constant bias shift method does not require any additional hardware circuitry. The illustrative method is fully implemented in controller firmware with conventional ADC and DAC ports of the controller as referenced above.

By virtue of the illustrative embodiment described in connection with FIGS. 6-8, the extinction ratio and average target output power may be maintained as desired without any a priori knowledge of the temperature and/or aging characteristics of a particular laser device. As a result of the illustrative method presently described, the extinction ratio and average power may be maintained continuously during operation. It is noted that the illustrative method may be effected iteratively. Illustratively, the present technique may be carried out at intervals of approximately a few hundred milli-seconds to approximately a few seconds. Finally, it is noted that the illustrative control apparatus and method may be applied to other devices besides the illustrative laser, as mentioned above.

The invention being thus described, it would be obvious that the same may be varied in many ways by one of ordinary skill in the art having had the benefit of the present disclosure. Such variations are not regarded as a departure from the spirit and scope of the invention, and such modifications as would be obvious to one skilled in the art are intended to be included within the scope of the following claims and their legal equivalents.

In the claims:

I claim:

1. A method of controlling an optical device, the method comprising:
calculating a ratio of a first slope of a first characteristic curve to a second slope of a second characteristic curve; and
calculating a modulation current based on said ratio.

2. A method as recited in claim 1, wherein the method further comprises:
a) reducing an optical output power of a laser device; and
b) determining a change in bias current due to said reducing of said output power.

3. A method as recited in claim 1, wherein said method is repeated at an interval of approximately a few hundred milliseconds to approximately a few seconds.

4. A method as recited in claim 2, wherein said output power is reduced in a range of approximately 2% to approximately 5%.

5. A method as recited in claim 2, wherein said output power is reduced by approximately 3%.

6. A method as recited in claim 1, wherein an average output power is substantially maintained by another method independently of the method.

7. A method as recited in claim 6, wherein said another method includes automated power control to change D.C. bias current.

8. A method as recited in claim 1, wherein calculating said ratio further comprises:
a) reducing an output optical power of a laser device by an amount;
b) determining a first change in a bias current;
c) repeating a);
d) determining a second change in said bias current; and
e) calculating a ratio of said first change to said second change.

9. A method as recited in claim 1, wherein said calculating of said modulation current further comprises:
multiplying said ratio by an initial modulation current.

10. A method as recited in claim 1, wherein the method further comprises:
a) reducing a bias current to a laser device; and
b) determining a change in optical output power due to said reducing of said bias current.

11. A method as recited in claim 10, wherein said bias current is reduced in a range of approximately 2% to approximately 5%.

12. A method as recited in claim 10, wherein said output power is reduced by approximately 3%.

13. A method as recited in claim 1, wherein calculating said ratio further comprises:
a) determining a bias current to a laser device by an amount;
b) calculating a first change in an optical output power;
c) repeating a);
d) determining a second change in said optical output power; and
e) calculating a ratio of said first change to said second change.

14. An apparatus for controlling an optical device, comprising:
a controller which calculates a ratio of a first slope of a first characteristic curve to a second slope of a second characteristic curve, and which calculates a modulation current based on said ratio; and a driver which introduces said modulation current to the optical device.

15. A controlling device as recited in claim 14, wherein a monitor photodetector receives a portion of an output signal from the optical device.

16. A controlling device as recited in claim 14, wherein the optical device is a laser device.

17. A controlling device as recited in claim 11, wherein said controller calculates said modulation current by multiplying said ratio by an initial modulation current.

18. A controlling device as recited in claim 14, wherein said controller commands said driver to reduce an optical output power of a laser device; and said controller calculates a change in bias current due to said reducing of said output power.

19. A controlling device as recited in claim 14, wherein said controller commands said driver to reduce a bias current to a laser device; and
said controller calculates a change in optical output power due to said reducing of said bias current.

20. A controlling device as recited in claim 14, wherein said controller calculates said ratio at an interval of approximately a few hundred milli-seconds to approximately a few seconds.
